(19) United States
(12) Patent Application Publication
(10) Pub. No.: US 2021/0409503 A1
(43) Pub. Date: Dec. 30, 2021

(54) PUSH NOTIFICATION DEVICE OF WARNING AREAS

(71) Applicant: TAIWAN NAME PLATE CO., LTD., Taoyuan City (TW)

(72) Inventors: WEN-CHENG YIN, NEW TAIPEI CITY (TW); CHI-HUNG CHANG, New Taipei City (TW); KAI-LI PENG, Taoyuan City (TW); CHIH-KAN CHIANG, Taoyuan City (TW)

(21) Appl. No.: 17/316,164

(22) Filed: May 10, 2021

(30) Foreign Application Priority Data
Jun. 24, 2020 (TW) 109208061

(51) Int. Cl. H04L 29/08; H04W 4/90

(52) U.S. Cl. CPC H04L 67/26; H04W 4/90

(57) ABSTRACT

A push notification device of warning areas is disclosed that comprising a transceiver connected to a third-party server to receive a plurality pieces of warning information from the third-party server. A processor determines whether a location information falling within a designated warning area of the plurality pieces of warning information based on a designated warning area of a push condition set by a push assembly, wherein the processor generates a warning signal if positive, or the processor determines another location information if negative. Then a notifier receives the warning signal, and performs a notifying operation based on the warning signal. Accordingly, as above-mentioned determination of warning areas, when the user is within the designated warning area, the push notification device can effectively alert the user to stay away from the warning area, thereby achieving the effect of warning prevention.

### CROSS-REFERENCE TO RELATED APPLICATION

The present disclosure is based upon and claims priority to Taiwan Patent Application No. 109208061, filed on Jun. 24, 2020, the content of which is incorporated herein by reference in its entirety for all purposes.

### BACKGROUND

### 1. Technical Field

The present disclosure relates to a field of push notification management, and more particularly to a push notification device that aimed at warning areas.

### 2. Description of the Related Art

Nowadays, technology is advancing rapidly with each passing day. The technology of smartwatches is also gradually maturing and multiple functions thereof are provided. Besides, if other applications are loaded, related functions can be further provided, such as step counting or measurement of attributes for a target of interest.

In addition, various kinds of disasters may happen from time to time, such as typhoons, earthquakes, epidemic diseases, or gas explosions, which greatly affect the lives of people. For example, Central Epidemic Command Center or Emergency Response Center will usually announce the location of the outbreak, so that people can know the outbreak location and avoid heading there.

However, when people want to know the relevant information, they must browse the official website to receive the relevant official information. For disasters like typhoon or gas explosion, people can obviously be aware of the location where the disaster is happening or the scenarios of damage caused. However, if people are within the range of the outbreak location, they usually cannot effectively know that they are in the warning areas of the outbreak location.

Therefore, how to provide a technology that can automatically and effectively alert the user that the user is in the warning area at present is worth considering in the field of push notification management, to improve the problems existing in the prior art.

### SUMMARY

According to the problems mentioned above, the purpose of the present disclosure is to provide a push notification device of warning areas, determining whether a location information of a user falling within a designated warning area of a plurality pieces of warning information by a processor, if positive, a notifier performs a notifying operation thereby to effectively alert the user to stay away from the warning area, thereby achieving the effect of warning prevention.

Based on the purpose of the present disclosure, which provides a push notification device of warning areas installed with a push application, the push notification device comprises: a transceiver in communication with a third-party server to receive a plurality pieces of warning information from the third-party server; a processor connected to the transceiver to receive the plurality pieces of warning information, the processor executing the push application to determine whether a location information falling within a designated warning area of the plurality pieces of warning information based on the designated warning area set by a push condition, wherein the processor generates a warning signal when the processor determined the location information falls within the designated warning area of the plurality pieces of warning information, or the processor determines another location information when the processor determined the location information does not fall within the designated warning area of the plurality pieces of warning information; a push assembly connected to the processor to receive the warning signal, and transmitting the push condition set by the push assembly; a notifier connected to the processor to receive the warning signal, and the notifier operating a notifying operation based on the warning signal.

In an embodiment, the third-party server includes a server of Central Epidemic Command Center or Emergency Response Center.

In an embodiment, the warning information includes a location, extent or scope of an epidemic or disaster.

In an embodiment, the push condition is respectively assigned with a level of the designated warning area according to the level of an outbreak in the plurality pieces of warning information.

In an embodiment, the notifier includes a display assembly, a lamp, a speaker, or any combinations of two or more thereof.

In an embodiment, the notifier is the display assembly, the notifier displays the warning signal on a display screen when the notifying operation is performed by the notifier.

In an embodiment, the notifier is the lamp, the notifier provides a light source during a warning period when the notifying operation is performed by the notifier.

In an embodiment, the notifier is the speaker, the notifier provides a warning sound during a warning period when the notifying operation is performed by the notifier.

In an embodiment, the push assembly provides a push interface to receive at least one setting signal, and generate the push condition according to the setting signal.

In an embodiment, the push notification device is a smart watch.

As described above, the push notification device of warning areas of the present disclosure can determine the location of the user by the processor, then notifying the user to stay away from the warning areas to achieve the purpose of warning prevention.

### BRIEF DESCRIPTION OF THE DRAWINGS

FIG. 1 illustrates a block diagram of the present disclosure.

FIG. 2 illustrates a block diagram of the connection to a third-party server of the present disclosure.

FIG. 3 illustrates an information transfer diagram of the present disclosure.

### DESCRIPTION OF THE PREFERRED EMBODIMENTS

The advantages, features, and technical methods of the present disclosure are to be explained in detail with reference to the exemplary embodiments and the drawings for a better understanding of the present disclosure. Moreover, the present disclosure may be realized in different forms, and should not be construed as being limited to the embodiments set forth herein. Conversely, for a person of ordinary skill in the art, the embodiments provided shall make the present disclosure convey the scope more thoroughly, comprehensively, and completely. In addition, the present disclosure shall be defined only by the appended claims.

The terms used in the present disclosure are only for the purpose of describing specific embodiments, not intended to limit the present disclosure. Unless otherwise defined, the technical terms or scientific terms used in the present disclosure shall have the usual meanings understood by those with ordinary skills in the field to which this disclosure belongs. The “one” or “a” or other similar words used in the specification of the present disclosure and the claims do not mean a limit of quantity, but mean that there is at least one. Unless otherwise stated, “including” or “comprising” or other similar words mean that the elements or objects before “including” or “comprising” contains the elements or objects or their equivalents listed after “including” or “comprising”, and other elements or objects are not excluded. Similar words such as “connection” or “connect” are not limited to physical or mechanical connections, and may include electrical connections, no matter whether direct or indirect. The singular forms of “a”, “the” and “this” used in the specification and claims of this disclosure are also intended to include plural forms, unless the context clearly indicates other meanings. It should also be understood that the term “and/or” as used herein refers to any or all possible combinations of one or more associated listed items.

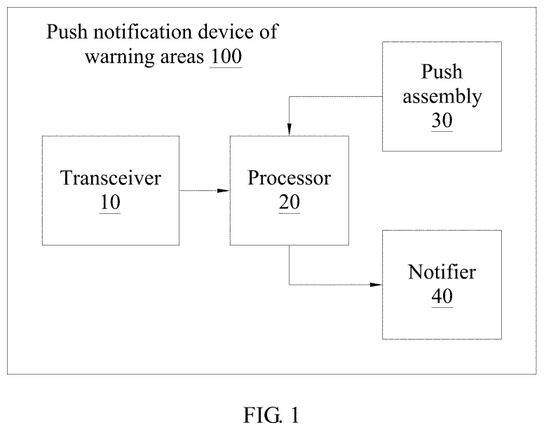

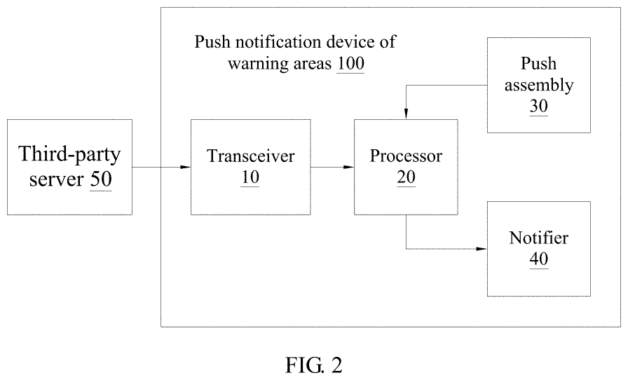

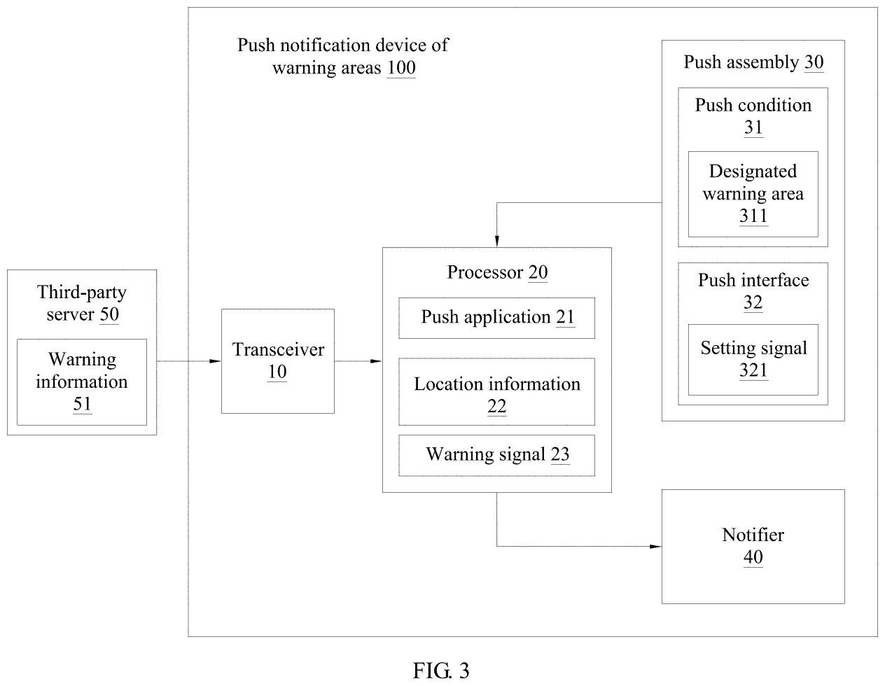

Please refer to FIGS. 1 to 3 which are a block diagram, a block diagram of the connection to a third-party server, and an information transfer diagram according to the present disclosure. As shown in the figures, a push notification device of warning areas 100 can be a smart watch, which primarily includes a transceiver 10, a processor 20, a push assembly 30, and a notifier 40. The transceiver 10 is suitable for receiving or transmitting external information. The processor 20 is utilized for processing, analyzing, or determining related information. The pushing assembly 30 is utilized for setting a pushing condition 31 and activating the notifier 40 to perform related notifying operation upon receiving the related signal. The notifier 40 is utilized to perform the notifying operation to alert the user.

Accordingly, the transceiver 10 receives a plurality pieces of warning information 51 from a third-party server 50 when the transceiver 10 is in communication with the third-party server 50. The aforementioned third-party server 50 may primarily include a server of the Central Epidemic Command Center or Emergency Response Center, which may obtain related warning information published by Central Epidemic Command Center or Emergency Response Center therefrom, and the warning information 51 may include a location, extent or scope of an epidemic or disaster. However, for the convenience of description, in the embodiment herein, the warning information published by Central Epidemic Command Center is taken as an example in the following description.

After the transceiver 10 obtains the warning information 51 (for example, a warning location information of an outbreak related-epidemic), the processor 20 connected to the transceiver 10 will receive the plurality pieces of warning information 51, and execute a push application 21, wherein the push application 21 mainly provides analysis logic and related threshold conditions to the processor 20, so that the processor 20 may process a determination of related warning areas by following the analysis logic and related threshold conditions. Therefore, when the processor 20 receives a push condition 31 from the push assembly 30 and a location information 22 of a user from a positioning assembly, the processor 20 determines whether the location information 22 falls within a designated warning area 311 (e.g. 100 meters, that is a radius of 100 meters centered on the warning location) which is set in the push condition 31. The processor 20 generates a warning signal 23 when the processor 20 determined the location information 22 falls within the designated warning area 311 of any one of the plurality pieces of warning information 51. Or the processor 20 determines another location information if the processor 20 determined the location information 22 does not fall within the designated warning area 311 of the plurality pieces of warning information 23.

The push assembly 30 is connected to the processor 20 for transmitting the push condition 31 set by the push assembly 30, wherein the push condition 31 can be provided by a push interface 32 of the push assembly 30 to receive at least one setting signal 321, and generate the push condition 31 according to the setting signal 321. Thus, the user is allowed to adjust and set the push condition 31 through the push interface 32 based on different warning conditions, to facilitate the processor 20 performs subsequent determinations following the push condition 31.

The notifier 40 is connected to the processor 20 to receive the warning signal 23 from the processor 20 and perform a notifying operation according to the warning signal 23. However, the formation of the notifying operation may depend on different setting types of the assemblies, components, or devices, thereby performing different types of notifying operations. For example, if the notifier 40 is a display assembly, the notifier 40 may display the warning signal 23 on a display screen when the notifier 40 executes the notifying operation. Specifically, the notifier 40 can graphically or textually display the information contained in the warning signal 23 on the display screen. Assuming the notifier 40 is a lamp, the notifier 40 provides a light source during a warning period (e.g. but not limited to 30 seconds, 45 seconds, or 1 minute) when the notifier 40 executes the notifying operation, wherein the light source can be performed in multiple modes, such as blinking, breathing, or strong lighting. When the notifier 40 is a speaker, the notifier 40 provides a warning sound during a warning period when the notifier 40 executes the notifying operation, wherein the warning sound needs to be a sound that can be noticed by the user.

Understandably, the above-mentioned notifier 40 may include at least one of the display assembly, the lamp, the speaker, or any combinations thereof.

Furthermore, since the extent of each epidemic or disaster is different, each of the designated warning areas 311 can be respectively assigned with a level according to the level of an outbreak based on the plurality pieces of warning information 51 when the user sets the push condition 31 through the push interface 32. For example, in a slight situation, the designated warning area 311 can be set to 30 meters; in a normal situation, the designated warning area 311 can be set to 70 meters; in a severe situation, the designated warning area 311 can be set to 100 meters.

In summary, the push notification device of warning areas of the present disclosure determines the location information of the user whether fall within the designated warning area of the warning information, and utilizing the notifier to perform the notifying operation to effectively alert the user to stay away from the warning area. Thereby achieving the effect of warning prevention to improve the problems existing in the prior art.

The above description is merely illustrative rather than restrictive. Any equivalent modifications or alterations without departing from the spirit and scope of the present disclosure are intended to be included in the following claims.

What is claimed is:

1. A push notification device of warning areas installed with a push application, the push notification device of warning areas comprising:
a transceiver in communication with a third-party server to receive a plurality pieces of warning information from the third-party server;
a processor connected to the transceiver to receive the plurality pieces of warning information, the processor executing the push application to determine whether a location information falling within a designated warning area of the plurality pieces of warning information based on the designated warning area set by a push condition, wherein the processor generates a warning signal when the processor determines the location information falls within the designated warning area of the plurality pieces of warning information, or the processor determines another location information when the processor determines the location information does not fall within the designated warning area of the plurality pieces of warning information;
a push assembly connected to the processor to receive the warning signal, and transmitting the push condition set by the push assembly;
a notifier connected to the processor to receive the warning signal, and the notifier performing a notifying operation based on the warning signal.

2. The push notification device according to claim 1, wherein the third-party server includes a server of Central Epidemic Command Center or Emergency Response Center.

3. The push notification device according to claim 1, wherein the warning information includes a location, extent or scope of an epidemic or disaster.

4. The push notification device according to claim 1, wherein the push condition is respectively assigned with a level of the designated warning area according to a level of an outbreak in the plurality pieces of warning information.

5. The push notification device according to claim 1, wherein the notifier includes a display assembly, a lamp, a speaker, or any combinations of two or more thereof.

6. The push notification device according to claim 5, wherein the notifier is the display assembly, the notifier displays the warning signal on a display screen when the notifying operation is performed by the notifier.

7. The push notification device according to claim 5, wherein the notifier is the lamp, the notifier provides a light source during a warning period when the notifying operation is performed by the notifier.

8. The push notification device according to claim 5, wherein the notifier is the speaker, the notifier provides a warning sound during a warning period when the notifying operation is performed by the notifier.

9. The push notification device according to claim 1, wherein the push assembly provides a push interface to receive at least one setting signal, and generate the push condition according to the setting signal.

10. The push notification device according to claim 1, wherein the push notification device is a smart watch.
